(19) United States
(12) Patent Application Publication
(10) Pub. No.: US 2024/0396191 A1
(43) Pub. Date: Nov. 28, 2024

(54) CONTACTLESS ROTARY JOINT FOR CONNECTING WAVEGUIDES

(71) Applicant: MacDonald, Dettwiler and Associates Corporation, Sainte-Anne-de-Bellevue (CA)

(72) Inventor: Karim Glâtre, Montreal (CA)

(21) Appl. No.: 18/666,940

(22) Filed: May 17, 2024

Related U.S. Application Data
(60) Provisional application No. 63/503,808, filed on May 23, 2023.

(51) Int. Cl. H01P 1/165

(52) U.S. Cl. CPC H01P 1/165

(57) ABSTRACT

Waveguide apparatuses having a rotary joint and methods of assembling and using the same are provided. The apparatus includes a first waveguide configured to circularly polarize and output a primary wave to a second waveguide via a first radio frequency (RF) interface, a second waveguide configured to receive the primary wave via a second RF interface and a contactless flange configured to physically and communicatively connect the first waveguide and the second waveguide wherein the first RF interface and the second RF interface are communicatively connected and not mechanically in contact. The physical connection is physically rotatable such that the communicative connection is maintained in rotation. The first waveguide may be configured to obtain the primary wave including receiving a first wave and a second wave and combining and circularly polarizing each wave or the combined wave.

### TECHNICAL FIELD

The following relates generally to rotary joints, and more particularly to contactless rotary joints for connecting waveguides.

### INTRODUCTION

In systems that include waveguides, such as antenna systems, it is often desirable for rotation between components to occur. This rotation may be to physically orient a component of system. For example, it may be desirable to orient an antenna relative to the device it supports, based on specific mission parameters. The rotation may further be to modify a wave passing through the system. For example, the rotation may be to change the orientation of the wave.

Through the rotation, communication must be maintained between the rotated components (of the waveguide and connecting system) to the stable or counter-rotated components. Rotary joints using circular polarization such as the rotary joint described in U.S. Pat. No. 3,906,407 to Levaillant et al. have been used maintain this communication. These rotary joints, however, typically place the waveguides in mechanical contact at the RF interface. This mechanical contact subjects the RF interface components of the waveguide to substantial friction and increases the risk of passive intermodulation (PIM). These friction and PIM issues generally result in reduced lifespan of the waveguides as well as a reduce the quality of the signal passing at the joint. The extent of these negative effects is increased the more the waveguides are rotated. Considering that joint rotation exacerbates these wear and performance issues, using rotary joints for operations that require frequent rotation, such as tracking antennas that require constant steering movement, may be avoided.

In existing systems, contactless rotary joints may be used to overcome the mechanical contact challenges. However, these systems achieve dual channels by changing modes. Changing modes, for example changing the waveguide fundamental mode to a coaxial mode, loses the ability to do the other channel. Dual channels using coaxial modes exist, but the insertion losses of those devices are typically high, and the power handling capabilities are also limited.

Accordingly, there is a need for an improved apparatus and method for rotary joints for connecting waveguides that overcomes at least some of the disadvantages of existing apparatuses and methods.

### SUMMARY

Provided herein is a waveguide apparatus having a rotary joint. The apparatus includes a first waveguide configured to receive a first wave and a second wave and output a combined wave to a second waveguide via a first radio frequency (RF) interface. The first waveguide includes a first polarizer configured to polarize each of the first wave and the second wave and combine the first wave and second wave to obtain the combined wave. The combined wave is a combination and circular polarization of the first wave and the second wave. The first polarizer includes a first in port configured to receive the first wave, a second in port configured to receive the second wave, and a first polarizer output port configured to output the circularly polarized combined wave. The second waveguide is configured to receive the combined wave from the first waveguide component via a second RF interface and output a first output wave and second output wave. The second waveguide includes a second polarizer configured to depolarize the combined wave and separate the combined wave to obtain the first output wave and the second output wave. The second polarizer includes a second polarizer input port configured to receive the combined wave, a first output port configured to output the first output wave, and a second in port configured to output the second output wave. The waveguide apparatus further includes a contactless flange configured to physically and communicatively connect the first waveguide and the second waveguide. The first RF interface and the second RF interface are communicatively connected and not mechanically in contact, and the physical connection of first waveguide to the second waveguide via the contactless flange is physically rotatable such that the communicative connection is maintained in rotation.

The polarization of the first wave and the second wave via the first polarizer is a polarization may be from a rectangular fundamental mode to a circular polarization.

The first wave may be in a first frequency range and the second wave may be in a second frequency range. The first frequency range and second frequency range may, at least in part, overlap.

The first polarizer and/or the second polarizer may include a septum polarizer and/or a corrugated polarizer.

The contactless flange may include a choke flange or a gap waveguide flange.

The first polarizer and the second polarizer may each comprise a septum polarizer and the contactless flange may comprise a gap waveguide flange.

The first RF interface and second RF interface may be separated by a gap comprising one or more of a fluid, air, and vacuum.

The first waveguide and the second waveguide may each further comprise at least one diplexer or at least one triplexer. The at least one diplexer or at least one triplexer may be for generating subchannels.

An antenna system comprising the waveguide apparatus. The antenna system may be configured to transmit or receive a signal including one or more waves.

The first RF interface may include the first polarizer output port.

The second RF interface may include the second polarizer input port.

Further provided herein is a waveguide apparatus including a first polarizer including a first RF interface configured to output at least one primary wave to a second polarizer, the second polarizer comprising a second RF interface configured to receive, from the first RF interface, the at least one primary wave, and a contactless flange. The contactless flange is configured to dispose the first waveguide and the second waveguide such that the first RF interface and the second RF interface are communicatively connected and not mechanically in contact. The contactless flange is further configured to physically connect the first polarizer and the second polarizer. The first polarizer, via the rotatable connection, is rotatable relative to the second polarizer. The communicative connection of the first RF interface relative to the second RF interface is maintained in rotation.

The first polarizer and the second polarizer may be a septum polarizer.

The contactless flange may be a gap waveguide flange.

The first polarizer may be further configured to receive and circularly polarize a first wave to obtain the primary wave.

The first polarizer may be further configured to receive and combine a first wave and a second wave to obtain the primary wave. The second polarizer may be further configured to separate the primary wave to obtain a first output wave and a second output wave.

The second polarizer may be further configured to depolarize the primary wave.

The first wave may be in a first frequency range and the second wave may be in a second frequency range. The first frequency range and second frequency range may, at least in part, overlap.

Further provided herein, is a method of assembling a waveguide apparatus for supporting multiple channels via a contactless rotary joint. The method includes connecting a first waveguide to a contactless flange of the contactless rotary joint. The first waveguide is configured to receive a first wave and a second wave and output a combined wave to a second waveguide via a first radio frequency (RF) interface. The first waveguide includes a first polarizer configured to polarize each of the first wave and the second wave and combine the first wave and second wave to obtain the combined wave. The combined wave comprises a combination and circular polarization of the first wave and the second wave. The first polarizer includes a first input port configured to receive the first wave, a second input port configured to receive the second wave and a first polarizer output port configured to output the circularly polarized combined wave. The method further includes connecting a second waveguide to the contactless flange of the contactless rotary joint. The second waveguide is configured to receive the combined wave from the first waveguide via a second RF interface and output a first output wave and second output wave. The second waveguide includes a second polarizer configured to depolarize the combined wave and separate the combined wave to obtain the first output wave and the second output wave. The second polarizer includes a second polarizer input port configured to receive the combined wave, a first output port configured to output the first output wave, and a second in port configured to output the second output wave. The contactless flange is configured to physically and communicatively connect the first waveguide and the second waveguide. The first RF interface and the second RF interface are communicatively connected and not mechanically in contact. The physical connection of first waveguide to the second waveguide via the contactless flange is physically rotatable such that the communicative connection is maintained in rotation.

Further provided herein is a method of supporting multiple channels in a waveguide apparatus via a contactless rotary joint. The method includes receiving by a first waveguide a first wave and a second wave, converting the first wave and the second wave to a circular polarization and combining the first wave and the second wave via a first polarizer of the first waveguide to obtain a combined wave. The method further includes outputting the combined wave from the first waveguide via a first RF interface of the first waveguide. The method further includes rotating one or more of the first RF interface and a second RF interface of a second waveguide from a first interface orientation to a second interface orientation of the first RF interface to the second RF interface. The method further includes receiving the combined wave by the second waveguide via the second RF interface. The method further includes depolarizing and reseparating via a second polarizer of the second waveguide the rotated combined waves to obtain a first output wave and a second output wave and outputting, from the second waveguide, the first output wave via a first output port of the second waveguide and the second output wave via a second output port of the second waveguide.

The method may further include rotating one or more of the first RF interface and the second RF interface to at least one additional interface orientation, outputting the combined wave from the first waveguide via the first RF interface in each additional interface orientation, receiving the combined wave by the second waveguide via the second RF interface in each additional interface orientation.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1 is a block diagram of a waveguide apparatus including a contactless rotary joint, according to an embodiment; and

FIG. 2 is a flowchart of a method of supporting multiple channels on a waveguide apparatus via a contactless rotary joint, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

A description of an embodiment with several components in contact or communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to rotary joints, and more particularly to rotary joints for connecting waveguides.

The apparatus of the present disclosure includes a rotary joint physically connecting two waveguides that enables rotation of the waveguides relative to each other. This rotation enables different mechanical rotated outputs of the waveguides.

Circular polarization of the signals in the waveguides enables two main channels. The two main channels correspond to one of the two circular polarizations, right hand circular (RHC) and left hand circular (LHC). Each main channel is defined by the corresponding polarization. Each channel may be used at the same time. Each channel may operate at the same frequency.

Each polarization (i.e., main channel) may be further separated into subchannels via a diplexer, triplexer, etc. to provide additional channels. Each subchannel within the main channel is defined by the corresponding diplexer, triplexer, etc.

The rotary joint includes a contactless flange. The contactless flange rotatably physically connects the two waveguides without mechanical contact at a radio frequency (RF) interface of the two waveguides. This enables 360 degrees or more of rotation between the two waveguides.

The lack of contact between the RF interface including the communicative components of the waveguides avoids penalties caused by friction such as wear and heating of the communicative components, particularly as the waveguides rotate relative to each other. Furthermore, PIM is mitigated as mechanical contact is not required. This lack of friction and mitigation of PIM beneficially improves the reliability of the system, as well as mitigates monitoring and management efforts necessary to address these issues.

Furthermore, the contactless nature of the contactless flange reduces the wear of the communicative components of the waveguides over contact based rotary joints. As the functioning of the communicative components are typically sensitive to wear and therefore may be failure point of the system, reducing the wear of the communicative components may extend the lifespan of the waveguide apparatus over existing system employing waveguide apparatuses with contact based rotary joints.

Additionally, contact based rotary joints may be rotated sparingly to avoid the above mentioned issues. Therefore, applications which require repetitive and frequent rotation may be avoided in systems utilizing these joints. By using a contactless flange, this concern is substantially avoided. Therefore, applications which require repetitive and frequent rotation are enabled by utilizing a contactless flange in the rotary joint. This enables, for example, rotary joints on steerable antennas for a low earth orbit (LEO) orbit. These antennae need to constantly repoint towards their target on earth which results in millions of degrees of operation during the antenna's lifetime.

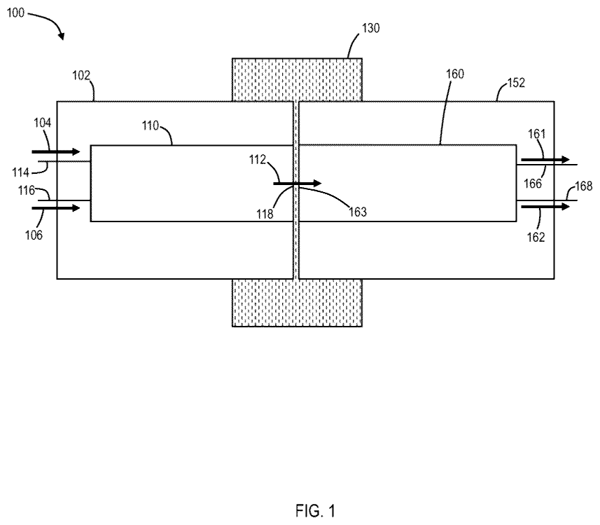

Referring now to FIG. 1, shown therein is a block diagram of a waveguide apparatus 100, according to an embodiment.

The waveguide apparatus 100 may be used as a wave communicating link between a first portion of a signal system and second portion of a signal system, where either or both portions rotate relative to each other. For example, the waveguide apparatus 100 may be a link between an antenna and a device that uses a signal the antenna receives. The antenna may be rotated to orient the antenna towards a source of the signal for better reception. This rotation occurs at the waveguide apparatus 100.

The waveguide apparatus 100 includes a first waveguide component 102. The first waveguide component 102 is configured to receive a first wave 104 and a second wave 106.

The first waveguide component 102 includes a first polarizer 110. The first polarizer 110 may be a septum polarizer, a corrugated polarizer, or any polarizing device.

The first polarizer 110 is configured to convert or transform the first wave 104 and the second wave 106, respectively, from a rectangular fundamental mode to a circular polarization and combine the circularly polarized waves to obtain a combined wave 112. The combined wave 112 is dually circularly polarized. It will be appreciated that the polarization and combination of the first wave 104 and second wave 106 may occur simultaneously or in any order.

The first polarizer 110 includes a first input port 114 and a second input port 116. The first input port 114 and second input port 116 are configured to receive the first wave 104 and the second wave 106, respectively. The first polarizer 110 further includes a first polarizer output port 118. The first polarizer output port 118 is configured to output the combined wave 112.

It will be appreciated that some embodiments may not include or use the second input port 116. In these embodiments, the combined wave 112 does not include the component corresponding to the second wave 106.

The waveguide apparatus 100 further includes a contactless flange 130. The contactless flange 130 is configured to rotatably communicatively connect the first waveguide component 102 with a second waveguide component 152, further described below. The component or components of the first waveguide component 102 that provides an RF interface between the first waveguide component 102 and the second waveguide component 152 are referred to as a first interface component. In some embodiments, the first interface component is the first polarizer output port 118. The component or components of the second waveguide component 152 that provides the RF interface between the first waveguide component 102 and the second waveguide component 152 are referred to as a second interface component. In some embodiments, the second interface component is a second polarizer input port 162, further described below. Collectively the first and second interface components are referred to as the interface components.

The contactless flange 130 is configured to rotatably physically connect the first waveguide component 102 and a second waveguide component 152. The contactless flange 130 may be part of a contactless rotary joint. The physical connection is rotatable such that when the first waveguide component 102 is rotated relative to the second waveguide component 152 the first interface remains communicatively connected to the second interface component. The circular polarization of the combined wave 112 renders the transmission of the combined wave through the communicative connection immune to the orientation of the interface components.

It will be appreciated that while rotating the first waveguide component 102 is described, the rotation described herein throughout the description is the relative rotation of the waveguides. Therefore, this rotation may also be achieved by rotating the second waveguide component 152 or parts thereof either alone or in combination with rotating the first waveguide component 102.

This physical connection is achieved without mechanical contact between the first interface component and the second interface component. In an example, the contactless flange 130 is configured to physically connect to an outer surface of the first waveguide component 102 and second waveguide component 152. The contactless flange 130 positions, via the connections to the first waveguide component 102 and the second waveguide component 152, the waveguides such that a gap is maintained between the first interface component and the second interface component. It will be appreciated that the gap may be an air gap, fluid gap or vacuum such as in space. In an embodiment, the contactless flange 130 is a choke flange. In another embodiment, the contactless flange 130 is a gap waveguide flange. The contactless flange 130 enables 360 degrees or more of rotation between the first waveguide component 102 and a second waveguide component 152 without mechanical penalties such as those due to friction or any risk of PIM issues.

The waveguide apparatus 100 further includes a second waveguide component 152. The second waveguide component 152 is configured to receive the combined wave 112 from the first waveguide component 102. The second waveguide component 152 is further configured to reseparate and output the received combined wave 112.

The second waveguide component 152 includes a second polarizer 160. The second polarizer 160 is configured to depolarize and reseparate the combined wave 112 received from the first waveguide component 102 to obtain a first output wave 161 and a second output wave 162. The first output wave 161 and second output wave 161 is substantially the same as the first wave 104 and second wave 106, respectively. The second polarizer 160 may be a septum polarizer, a corrugated polarizer, or any polarizing device.

The second polarizer 160 includes a second polarizer input port 163. The second polarizer input port 163 is configured to receive the combined wave 112. As the combined wave 112 is circularly polarized, the combined wave 112 received by the second polarizer input port 163 from the first polarizer output port 118 is substantially unchanged irrespective of the rotational orientation of the second polarizer input port 163 relative to the first polarizer output port 118.

The second polarizer 160 further includes a first out port 166 and a second out port 168. The first out port 166 and second out port 168 are configured to output the first output wave 161 and the second output wave 162, respectively.

In an embodiment, the first polarizer 110 is configured as a septum polarizer back to back with second polarizer 160 also configured as a septum polarizer connected with a gap waveguide flange. In another embodiment, the first polarizer 110 is configured as an E-band septum polarizer back to back with second polarizer 160 configured as a corrugated polarizer connected with a choke flange.

The first waveguide component 102 and second waveguide component 152 may be configured to support a predetermined maximum number of channels in addition to the two channels supported by the circular polarization of the of the combined wave 112. The number of channels the waveguide apparatus 100 can support may depend on a bandwidth supported by each waveguide component 102, 152. The number of channels a waveguide can support may further depend on the number of ports provided by each waveguide component 102, 152. The waveguide may include diplexers, triplexers, etc. which provide various numbers of ports.

For example, the first waveguide component 102 may include a diplexer at each of the first input port 114, second input port 116. The second waveguide component 152 may include corresponding diplexers at the first out port 166 and second out port 168. The diplexers would provide four ports on the first waveguide component 102 and four ports on the second waveguide component 152. The four ports would support the separation of frequency bands such as, a Ka Transmit (Tx) frequency band (17.3 to 20.2 GHz) and a Ka Receive (Rx) frequency band (28 to 30 GHZ).

In some embodiments the first waveguide component 102 and the second waveguide component 152 may not provide the same number of ports. In these embodiments, channels would be lost due to the discrepancy in ports. However, it will be appreciated that this may be of use in some embodiments.

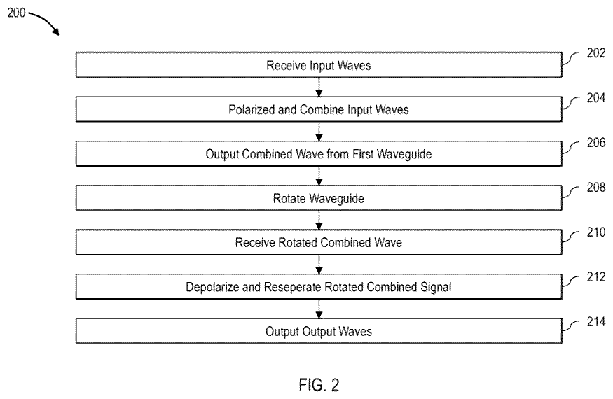

Referring to FIG. 2, shown therein is a flowchart of a method 200 of supporting multiple channels in a waveguide apparatus via a contactless rotary joint, according to an embodiment. The method 200 may be implemented using the waveguide apparatus 100 of FIG. 1.

At 202, a first wave is received by a first waveguide component. A second wave may also be received by the first waveguide component. It will be appreciated that in embodiments where a second wave is not received by the second waveguide component, steps concerning the second wave (i.e. polarizations of the second wave, and combinations or separations including the second wave), described below, are not necessary and the method may be practiced without said steps. Embodiments that include additional ports receiving additional waves are expressly contemplated.

At 204, the first wave and second wave are each converted or transformed from a fundamental mode in the waveguide input to a circular polarization and combined into a combined wave via a first polarizer.

At 206, the combined wave is output from the first waveguide component via a first RF Interface. The first RF interface may be an output port of the first polarizer.

At 208, the first waveguide component is rotated relative to the second waveguide via a contactless flange of a contactless rotary joint. The communicative contact between the first RF interface and the second RF interface is maintained through the rotation. It will be appreciated that while rotating the first waveguide component is described, rotating the second waveguide alone or in addition to the first waveguide component to achieve the relative rotation is expressly contemplated.

At 210, the combined wave is received by the second waveguide via a second RF interface. The second RF interface may be an input port of the second polarizer. It is expressly contemplated that the rotation, at 208, may occur before, at, after, or concurrent with any part of the method including before, at, after, or concurrently with steps 206 and 210. The wave may be continuously transmitted (or received) during the rotation of the rotary joint.

At 212, the combined signal is depolarized and reseparated via a second polarizer of the second waveguide component to obtain a first output wave and a second output wave.

At 214, the first output wave and the second output wave are output from the second waveguide component via a first output port and a second output port, respectively.

While the above description provides examples of one or more apparatus, methods, or systems, it will be appreciated that other apparatus, methods, or systems may be within the scope of the claims as interpreted by one of skill in the art.

1. A waveguide apparatus comprising:
a first polarizer comprising a first radio frequency (RF) interface configured to output at least one primary wave to a second polarizer;
the second polarizer comprising a second RF interface configured to receive, from the first RF interface, the at least one primary wave; and
a contactless flange configured to:
dispose the first polarizer and the second polarizer such that the first RF interface and the second RF interface are communicatively connected and not mechanically in contact; and
physically connect the first polarizer and the second polarizer wherein the first polarizer is rotatable relative to the second polarizer via the connection and wherein the communicative connection of the first RF interface relative to the second RF interface is maintained in rotation.

2. The apparatus of claim 1, wherein the first polarizer or the second polarizer comprises a septum polarizer or a corrugated polarizer.

3. The apparatus of claim 1, wherein the contactless flange comprises a choke flange or a gap waveguide flange.

4. The apparatus of claim 1, wherein the first polarizer and the second polarizer each comprise a septum polarizer and the contactless flange comprises a gap waveguide flange.

5. The apparatus of claim 1, wherein the first RF interface and second RF interface are separated by a gap comprising one or more of a fluid, air, and vacuum.

6. An antenna system comprising the apparatus of claim 1, the antenna system configured to transmit or receive a signal comprising one or more waves.

7. The apparatus of claim 1, wherein the first polarizer is further configured to receive and circularly polarize a first wave to obtain the primary wave.

8. The apparatus of claim 1, wherein the second polarizer is further configured to depolarize the primary wave.

9. The apparatus of claim 1, wherein the first polarizer is further configured to receive and combine a first wave and a second wave to obtain the at least one primary wave.

10. The apparatus of claim 1, wherein the second polarizer is further configured to separate the primary wave to obtain a first output wave and a second output wave.

11. The apparatus of claim 9, wherein the first wave is in a first frequency range and the second wave is in a second frequency range wherein the first frequency range and second frequency range, at least in part, overlap.

12. The apparatus of claim 9, wherein the polarization of the first wave and the second wave via the first polarizer is to a circular polarization.

13. The apparatus of claim 12, wherein the polarization is from a rectangular fundamental mode.

14. The apparatus of claim 9, further comprising:
a first waveguide configured to receive the first wave and the second wave and output the at least one primary wave to a second waveguide via the first RF interface, the first waveguide comprising:
the first polarizer further configured to circularly polarize each of the first wave and the second wave and combine the first wave and second wave to obtain the at least one primary wave, wherein the at least one primary wave is a combination and circular polarization of the first wave and the second wave, the first polarizer comprising:
a first in port configured to receive the first wave;
a second in port configured to receive the second wave; and
a first polarizer output port configured to output the at least one primary wave;
the second waveguide configured to receive the combined wave from the first waveguide via the second RF interface and output a first output wave and second output wave, the second waveguide comprising:
the second polarizer further configured to depolarize the at least one primary wave to obtain a first output wave and a second output wave, the second polarizer comprising:
a second polarizer input port configured to receive the at least one primary wave;
a first output port configured to output the first output wave; and
a second output port configured to output the second output wave; and
wherein the contactless flange is further configured to physically and communicatively connect to physically connect the first waveguide and the second waveguide, the physical connection physically rotatable such that the communicative connection of the first RF interface and the second RF interface is maintained in rotation.

15. The apparatus of claim 13, wherein the first waveguide and the second waveguide each further comprise at least one diplexer or at least one triplexer.

16. The apparatus of claim 13, wherein the first RF interface comprises the first polarizer output port.

17. The apparatus of claim 13, wherein the second RF interface comprises the second polarizer input port.

18. A method of assembling a waveguide apparatus for supporting multiple channels via a contactless rotary joint, the method comprising:
connecting a first waveguide to a contactless flange of the contactless rotary joint, the first waveguide configured to receive a first wave and a second wave and output a combined wave to a second waveguide via a first radio frequency (RF) interface, wherein the first waveguide comprises:
a first polarizer configured to polarize each of the first wave and the second wave and combine the first wave and second wave to obtain the combined wave wherein the combined wave comprises a combination and circular polarization of the first wave and the second wave, the first polarizer comprising:
a first input port configured to receive the first wave;
a second input port configured to receive the second wave; and
a first polarizer output port configured to output the circularly polarized combined wave;
connecting a second waveguide to the contactless flange of the contactless rotary joint, the second waveguide configured to:
receive the combined wave from the first waveguide via a second RF interface and output a first output wave and second output wave, the second waveguide comprising:
a second polarizer configured to depolarize the combined wave and separate the combined wave to obtain the first output wave and the second output wave, the second polarizer comprising:
a second polarizer input port configured to receive the combined wave;
a first output port configured to output the first output wave; and
a second in port configured to output the second output wave; and
wherein the contactless flange is configured to physically and communicatively connect the first waveguide and the second waveguide, wherein the first RF interface and the second RF interface are communicatively connected and not mechanically in contact, and wherein the physical connection of first waveguide to the second waveguide via the contactless flange is physically rotatable such that the communicative connection is maintained in rotation.

19. A method of supporting multiple channels in a waveguide apparatus via a contactless rotary joint, comprising:
receiving by a first waveguide a first wave and a second wave;
converting the first wave and the second wave to a circular polarization and combining the first wave and the second wave via a first polarizer of the first waveguide to obtain a combined wave;
outputting the combined wave from the first waveguide via a first RF interface of the first waveguide;
rotating one or more of the first RF interface and a second RF interface of a second waveguide from a first interface orientation to a second interface orientation of the first RF interface to the second RF interface;
receiving the combined wave by the second waveguide via the second RF interface;
depolarizing and reseparating via a second polarizer of the second waveguide the rotated combined waves to obtain a first output wave and a second output wave; and
outputting, from the second waveguide, the first output wave via a first output port of the second waveguide and the second output wave via a second output port of the second waveguide.

20. The method of claim 18 further comprising rotating one or more of the first RF interface and the second RF interface to at least one additional interface orientation, outputting the combined wave from the first waveguide via the first RF interface in each additional interface orientation, receiving the combined wave by the second waveguide via the second RF interface in each additional interface orientation.
